(19) United States
(12) Patent Application Publication
(10) Pub. No.: US 2013/0027332 A1
(43) Pub. Date: Jan. 31, 2013

(54) PROJECTION SYSTEM WITH TOUCH CONTROL

(71) Applicants: Jar-Ferr YANG, Tainan City (TW); Chi-Kun Lin, Tainan City (TW); Cheng-Mao Li, Tainan City (TW)

(72) Inventors: Jar-Ferr YANG, Tainan City (TW); Chi-Kun Lin, Tainan City (TW); Cheng-Mao Li, Tainan City (TW)

(21) Appl. No.: 13/557,753

(22) Filed: Jul. 25, 2012

(30) Foreign Application Priority Data
Jul. 26, 2011 (TW) 100126399

(51) Int. Cl. G06F 3/041

(52) U.S. Cl. 345/173

(57) ABSTRACT

A projection system with touch control includes a touch device, a projection device and a control module. The touch device has plural touch plates which can be combined to form a plane. The projection device has plural projection units which can project on the plane respectively so as to form a projection image on the plane. The control module is electrically connected with the touch plates and the projection units for controlling the projection device to change the projection image corresponsively as a user touches the projection image projected on the plane. Herein, the touch plates can be combined to form a plane, and the user can interact with the projection image projected on the plane.

### CROSS REFERENCE TO RELATED APPLICATIONS

This Non-provisional application claims priority under 35 U.S.C. §119(a) on Patent Application No(s). 100126399 filed in Taiwan, Republic of China on Jul. 26, 2011, the entire contents of which are hereby incorporated by reference.

### BACKGROUND OF THE INVENTION

1. Field of Invention

The present invention relates to a touch projection system including plural combinable touch plates.

2. Related Art

In an interactive projection system with touch control function, the projection technology and the touch technology are combined such that the projection image can be correspondingly changed when the user touches the projection image projected onto the touch device, and the interactive effect with the user can be generated. As shown in FIG. 1, the conventional projection technology and touch technology are combined and applied to the restaurant order in an actual example.

Referring to FIG. 1, a touch projection device 1 (i.e., an interactive electronic order system) includes a dining table device 11, an order computer host 12 and a projector 13. The order computer host 12 is electrically connected to the dining table device 11 and the projector 13. A touch panel 111 is disposed on a desktop of the dining table device 11. In addition, the order computer host 12 can deliver the meal information of the restaurant to the projector 13, and the projector 13 can project the meal information onto the touch panel 111 of the dining table device 11. The customer can perform the operations, such as ordering, querying, calling the service personnel or checking out, according to the projection information displayed on the touch panel 111. Thus, the touch projection device 1 can provide the customer the effective interactive order function.

The projector 13 of the touch projection device 1 only can project the order information onto one touch panel 111 of one dining table device 11, so that the area, which can be touched by and interacted with the user, is relatively restricted. Sometimes, it is desired to extend the application of the touch surface, e.g. extending the touch surface to a tabletop, a floor or a wall, which allows more users to perform interactive touch control through large touch surface. However, the touch projection system 1 can not satisfy this requirement.

Therefore, it is an important subject of the present invention to provide a touch projection system that is configured with plural touch plates, which can be combined to form a plane, so that the user(s) can perform the interactive touch control through the image projected on the plane.

### SUMMARY OF THE INVENTION

In view of the foregoing subject, an objective of the present invention to provide a touch projection system that is configured with plural touch plates, which can be combined to form a plane, so that the user(s) can perform the interactive touch control through the image projected on the plane.

To achieve the above objective, the present invention discloses a touch projection system, including a touch device, a projection device, and a control module. The touch device has a plurality of touch plates, which are combinable to form a plane. The projection device has a plurality of projection units, which project on the plane respectively so as to form a projection image on the plane. The control module is electrically connected with the touch plates and the projection units for controlling the projection device to change the projection image corresponsively as a user touches the projection image projected on the plane.

In one embodiment, the touch plates comprise capacitive, resistive, supersonic, optical or EMR (electromagnetic resonance) touch plates.

In one embodiment, the touch plates are combined on a floor, a wall or a tabletop to form the plane.

In one embodiment, the control module divides an image into a plurality sub-images, the projection unit separately projects the sub-images on a plurality of projection areas of the plane, and each of the projection areas is projected with a projection sub-image.

In one embodiment, two adjacent projection sub-images have partial overlapped images, and the projection areas have partial overlapped areas.

In one embodiment, the control module fuses the images in the overlapped area.

In one embodiment, the control module controls to enable one of the projection units to project an alignment mark within the corresponding projection area, thereby performing the position and calibration of the projection sub-image with respect to the touch plates.

In one embodiment, when a calibration element is disposed on the alignment mark, the control module receives a position signal from the touch plate of the calibration element for performing the position and calibration of the display position of the projection sub-image.

In one embodiment, when the calibration element is disposed on the alignment mark, the calibration element is grounded.

In one embodiment, when the user touches the projection image of the plane, the corresponsive touched touch plate generates a touch signal, and the control module receives the touch signal and controls the projection device to project another projection image according to the touch signal.

As mentioned above, the projection system of the invention comprises a touch device having a plurality of touch plates capable of combining a plane. Besides, the projection system has a plurality of projection units for projecting onto the plane to form a projection image thereon. The control module is electrically connected with the touch plates and the projection units, and controls the projection device to change the projection image corresponsively as a user touches the projection image projected on the plane. When the user touches the projection image on the touch plates, the control module receives the touch signal from the touch plate, and then controls the projection device to project another projection image onto the plane according to the touch signal, thereby providing the desired interaction effect. In brief, the projection system of the invention includes the touch plates combining to form a plane, so that the touch interaction between the user and the projection image formed on the plane can be carried out.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic diagram showing a conventional touch projection system;

FIG. 2A is a schematic diagram showing a touch projection system according to a preferred embodiment of the invention;

FIG. 2B is a schematic diagram showing a projection image composed by four projection sub-images;

FIG. 3A is a schematic diagram showing an image, which is divided into a plurality of sub-images;

FIG. 3B is a schematic diagram showing the projection areas and the corresponding touch plates of the touch projection system of the invention; and

FIGS. 4A and 4B are schematic diagrams for illustrating the position and calibration of the touch projection system of the invention.

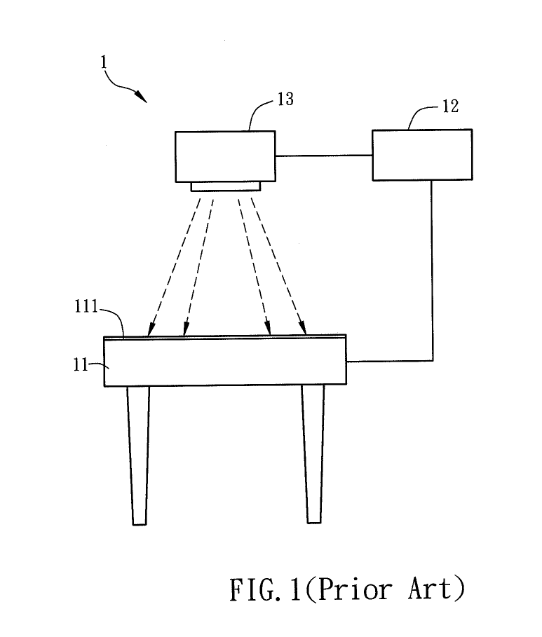

### DETAILED DESCRIPTION OF THE INVENTION

The present invention will be apparent from the following detailed description, which proceeds with reference to the accompanying drawings, wherein the same references relate to the same elements.

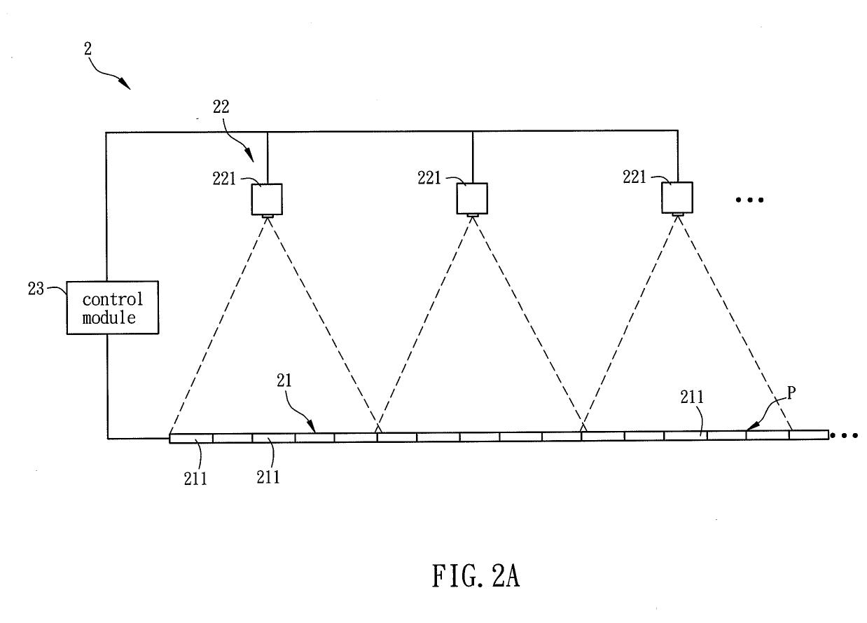

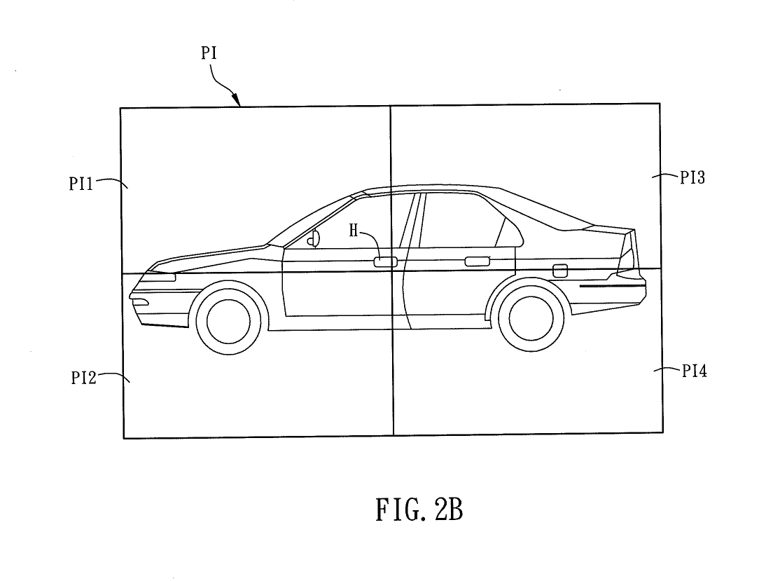

FIG. 2A is a schematic diagram showing a touch projection system 2 according to a preferred embodiment of the invention. The touch projection system 2 contains a plurality of combinable touch plates, which are applied to the ground, wall or tabletop (with a large area), so that the user can interact with the projection image, which is projected on the ground, wall or tabletop. Referring to FIG. 2A, the touch projection system 2 includes a touch device 21, a projection device 22, and a control module 23.

The touch device 21 has a plurality of touch plates 211, which can be combined to form a plane P. The touch plates 211 are electrically connected and capable of combining a complete plane P on, for example but not limited to, the ground, wall or tabletop. In this embodiment, the touch plates 211 can combine a complete plane P on the ground. Of course, the user may configure the touch plates 211 on the wall, tabletop or other suitable place so as to form the plane P with large area and touch control function.

The touch plate 211 is a capacitive touch panel for example. In general, the capacitive touch panel has the advantages of dustproof, anti-flame, anti-fire, scratch-proof, high durability, and high resolution. Since human body is conductive, the small leaking current from the human body can change the voltage level of the capacitors of the capacitive touch panel when touching it. Then, the capacitive touch panel can calculate the coordinates of the touched position based on the variations of the voltage level. To be noted, the touch plate of the present invention is not limited to the above capacitive touch panel, and it can be any applicable touch panel, such as the resistive, supersonic, optical (e.g. IR), or EMR (electromagnetic resonance) touch panel, according to the requirements of design. In addition, the touch plates 211 may further include a protective layer (not shown in FIG. 2A), which is made of glass, resin, or other non-conductive materials. The protective layer is disposed on the touch plate 211 for protecting it from interference or damage by other objects.

The projection device 22 has a plurality of projection units 221, which project on the plane P composed of the touch plates 211 so as to form a complete projection image (not shown in FIG. 2A) on the plane P (or the touch plates 211). For example, each projection unit 221 is a projector for projecting a static image or a dynamic image. To be noted, each of the projection units 221 separately projects a smaller projection sub-image to the corresponding touch plate 211, so that the complete projection image composed of the projection sub-images can be formed on the plane P. As shown in FIG. 2B, four projection units 221 (not shown) are configured to separately project a part of a car image, wherein the four projection units 221 respectively project the projection sub-images PI1-PI4. Accordingly, the four projection sub-images PI1-PI4 are perfectly combined to present a complete projection image PI (an entire car).

In addition, since the projection units 221 usually have different qualities, the shapes of the projected areas may be a little deformed. The normal projected area of the projection unit 221 is square or rectangular; however, the deformed projected area is, for example, trapezoid. In this case, it is necessary to calibrate the projection unit 221 with the deformed projected area in advance so as to make the projected area of each projection unit 221 to be square or rectangular.

To be note, the touch plate 211 of the invention has a planar surface in any size. Regarding to the combination and installation, the size of the touch plate 211 is preferably a 50 cm×50 cm square, and the projection image of a projection device 22 is approximately covering 48 touch plates 211. However, the present invention is not limited to this example. The number of the touch plates 211 or the number of the projection device 22 is not limited here, and their numbers can be determined based on the area of the applied ground, wall or tabletop.

The control module 23 is electrically connected with the touch plates 211 and the projection units 221. When a user touches the projection image PI projected on the plane P (the touch plates 211), the control module 23 controls the projection device 22 to change the projection image PI corresponsively. In other words, when the user touches the projection image PI projected on the touch plates 211, the touched touch plate 211 generates a touch signal with respect to the touched position and transfers the touch signal to the control module 23. Then, the control module 23 controls the projection unit(s) 221 corresponding to the touched position to change the projection image PI. Thus, the user can interact with the projection image PI.

In the following example, the control module 23 is configured to control four projection units 221 simultaneously, so that the four projection units 221 respectively project the projection sub-images PI1-PI4, which combine to form a complete projection image PI. Of course, based on the following description, it is possible to configure more touch plates 211 and more projection units 221 depending on the actual needs.

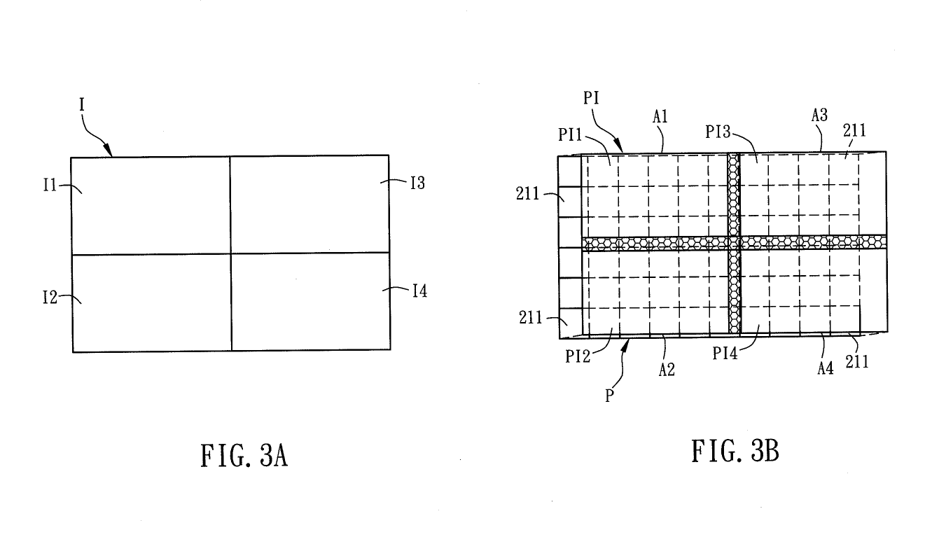

Referring to FIGS. 3A and 3B, the control module 23 firstly divides an image I into a plurality of sub-images I1-I4. Then, the projection units 221 respectively project the sub-images I1-I4 on the plane P so as to form the projection areas A1-A4 on the plane P. Herein, the projection areas A1-A4 are projected with the projection sub-images PI1-PI4. Each of the projection areas A1-A4 may cover multiple touch plates 211. In addition, two adjacent projection sub-images have partial overlapped images. That is, the projection areas A1-A4 have partial overlapped portions. In this embodiment, the overlapped portions of two adjacent projection areas are about 7-8% of the projection areas A1-A4.

In more detailed, the control module 23 firstly divides the image I into multiple sub-images I1-I4, and transmits the image signals of the sub-images I1-I4 to the corresponding four projection units 221, respectively. Then, the four projection units 221 project the sub-images I1-I4 onto the projection areas A1-A4 so as to form the projection sub-images PI1-PI4 on the projection areas A1-A4, respectively. As a result, the projection sub-images PI1-PI4 combine to form the projection image PI.

To be noted, in order to make the projection image PI be continuous and smooth on the plane P, the partially overlapped portions of the projection sub-images PI1-PI4 are treated by image fusion process. The partially overlapped portions are also referred to the overlapped areas of the projection areas A1-A4 (the cross region of FIG. 3B). Accordingly, the image, color and brightness of the overlapped areas become smoother, so that the projection image PI composed of the projection sub-images PI1-PI4 is displayed as a smooth and complete image. Herein, the control module 23 fuses the overlapped portions of the projection sub-images PI1-PI4 in advance, so the projection image PI can be looked like a smooth and complete image.

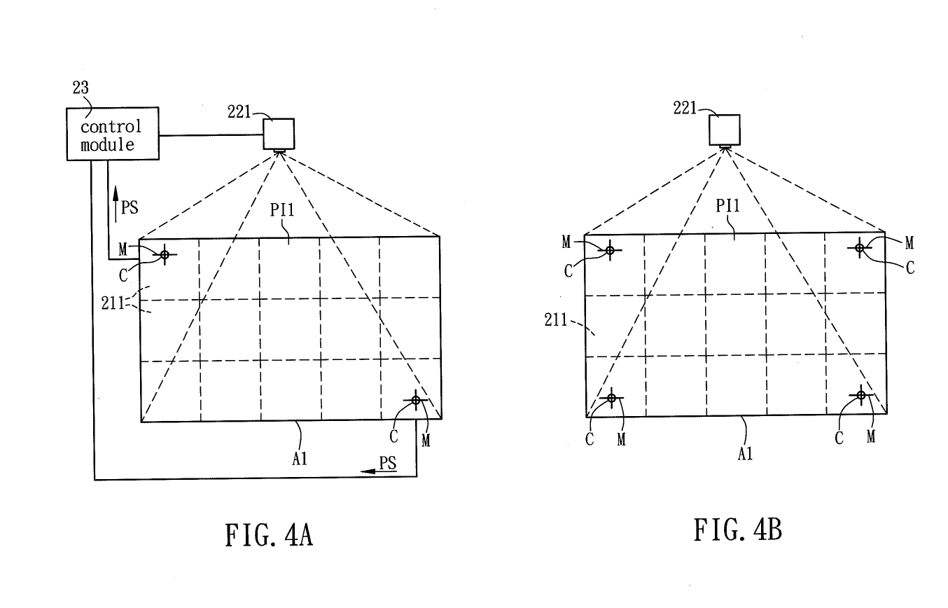

In addition, the plane P is configured by a plurality of touch plates 211, so that it is necessary to perform the position and calibration between the projection image PI and the touch plates 211. Thus, the correct interaction between the touched position of the touch plate 211 and the corresponding projection unit 221 can be conducted. Hereinafter, the position and calibration between the projection sub-image and the touch plates 211 of the projection area will be described with reference to FIG. 4A. FIG. 4A is a schematic diagram showing a projection unit 221 projecting a projection sub-image PI1.

At first, the control module 23 controls to enable one of the projection units 221 to project an alignment mark M within the corresponding projection area A1, thereby performing the position and calibration of the projection sub-image PI1 with respect to the touch plates 211. Herein, the alignment mark M is a cross mark, and of course, it can be any type of mark. In other words, the control module 23 disables all projection units 211 except for the projection unit 211 corresponding to the projection area A1, so that this enabled projection unit 211 projects the alignment mark M on the projection area A1. The purpose of disabling the other projection units 211 is to avoid the undesired interference to the position and calibration caused by the image overlapped portions on the projection area A1.

Next, a calibration element C is disposed on the alignment mark M. When the calibration element C contacts with the touch plate 211, the voltage level of the capacitor of the touch plate 211 is changed to generate a position signal PS. The control module 23 receives the position signal PS from the touch plate 211 for performing the position and calibration of the display position of the projection sub-image PI1.

In more details, the touch plate 211 responses the position signals PS of two calibration elements C to the control module 23, and the control module 23 performs the position and calibration of the display position corresponding to the projection sub-image PI1. Accordingly, the actual position of the touch plate 211 can match with the display position of the projection sub-image PI1, thereby establishing the relative relationship between the projection area A1 and the projection sub-image PI1. Thus, the control module 23 can align the projection sub-image PI1 of the projection unit 211 with the actual position of the touch plate 211. According to the above procedure, the position and calibration between the touch plate 211 of the projection area A1 and the projection sub-image PI1 of the projection unit 221 can be completed.

Regarding to the other projection areas A2-A4, the positions and calibrations between the actual positions of the touch plates 211 and the display positions of the projection sub-images PI2-PI4 can also be performed by the similar procedures, thereby finishing the positions and calibrations between the projection image PI and all touch plates 211.

To be noted, the calibration element C is a conductive element. Since the touch plate 211 of the invention functions by detecting the electrical variation between the object and the touch plate 211, the organisms are usually grounding conductors with irregular shapes and different sizes, and the users usually have different electrical properties, the calibration elements C that are grounding metals with the same size can keep the reference electrical property to be constant. In addition, when the calibration element C is disposed on the alignment mark M, the calibration element C must be grounded, so that the charges of the calibration elements C can freely flow therebetween to generate the voltage difference. Besides, the number of the alignment marks M projected by the projection units 221 is not limited to 2. As shown in FIG. 4B, it is possible to project 4 or 3 alignment marks M on the four (or three) corners of the projection area A1, and configure four (or three) calibration elements C on the alignment marks M respectively. In general, more calibration elements C can result more precise position and calibration.

It is noted that the above-mentioned position and calibration are only an example, and the user may adopt other method to perform the desired position and calibration. For example, the projection units 221 are all enabled, the alignment marks M are projected at the centers of the projection areas A1-A4 (not shown), and two or more calibration elements C are disposed around the alignment marks M. Accordingly, the position and calibration can also be finished. Of course, the position and calibration method is not limited to the above approaches, and can be any usable method.

After the position and calibration processes, when the user touches the projection images on the touch plates 211, the touched touch plate 211 generates a touch signal, and the control module 23 receives the touch signal and controls the corresponding projection unit 221 of the projection device 22 to project another projection image to the projection area according to the touch signal. The following description will take a car as shown in FIG. 2B as an example. When the user touches the handle H of the car, the touch plate 211 corresponding to the position of the handle H (not shown in FIG. 2B) generates a touch signal and sends it to the control module 23 (not shown in FIG. 2B). According to the received touch signal, the control module 23 then controls the corresponding projection unit 221 (not shown in FIG. 2B) to project another projection image. For instance, another projection image may show an opened car door, so that the user can see the inside configuration of the car. Of course, any other interactive contents can be shown (e.g. playing music simultaneously). As a result, the projection image can show an interaction with the user.

In summary, the projection system of the invention comprises a touch device having a plurality of touch plates capable of combining a plane. Besides, the projection system has a plurality of projection units for projecting onto the plane to form a projection image thereon. The control module is electrically connected with the touch plates and the projection units, and controls the projection device to change the projection image corresponsively as a user touches the projection image projected on the plane. When the user touches the projection image on the touch plates, the control module receives the touch signal from the touch plate, and then controls the projection device to project another projection image onto the plane according to the touch signal, thereby providing the desired interaction effect. In brief, the projection system of the invention includes the touch plates combining to form a plane, so that the touch interaction between the user and the projection image formed on the plane can be carried out.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A projection system, comprising:
a touch device having a plurality of touch plates, wherein the touch plates are combinable to form a plane;
a projection device having a plurality of projection units, wherein the projection units project on the plane respectively so as to form a projection image on the plane; and
a control module electrically connected with the touch plates and the projection units for controlling the projection device to change the projection image corresponsively as a user touches the projection image projected on the plane.

2. The projection system of claim 1, wherein the touch plates comprise capacitive, resistive, supersonic, optical or EMR (electromagnetic resonance) touch plates.

3. The projection system of claim 1, wherein the touch plates are combined on a floor, a wall or a tabletop to form the plane.

4. The projection system of claim 1, wherein the control module divides an image into a plurality sub-images, the projection unit separately projects the sub-images on a plurality of projection areas of the plane, and each of the projection areas is projected with a projection sub-image.

5. The projection system of claim 4, wherein adjacent two of the projection sub-images have partial overlapped images, and the projection areas have partial overlapped areas.

6. The projection system of claim 5, wherein the control module fuses the images in the overlapped area.

7. The projection system of claim 4, wherein the control module controls to enable one of the projection units to project an alignment mark within the corresponding projection area, thereby performing the position and calibration of the projection sub-image with respect to the touch plates.

8. The projection system of claim 7, wherein when a calibration element is disposed on the alignment mark, the control module receives a position signal from the touch plate of the calibration element for performing the position and calibration of the display position of the projection sub-image.

9. The projection system of claim 8, wherein when the calibration element is disposed on the alignment mark, the calibration element is grounded.

10. The projection system of claim 1, wherein when the user touches the projection image of the plane, the corresponsive touched touch plate generates a touch signal, and the control module receives the touch signal and controls the projection device to project another projection image according to the touch signal.
